(19) United States
(12) Patent Application Publication
(10) Pub. No.: US 2011/0315935 A1
(43) Pub. Date: Dec. 29, 2011

(54) METHOD FOR DISPERSING NANOPARTICLES IN FLUID MEDIA

(75) Inventors: Sigrun Stein, Leverkusen (DE); Maren Heinemann, Bergisch Gladbach (DE); Thomas König, Leverkusen (DE); Udo Dünger, Leverkusen (DE)

(73) Assignee: Bayer Technology Services GMBH, Leverkusen (DE)

(21) Appl. No.: 13/203,926

(22) PCT Filed: Mar. 12, 2010
(86) PCT No.: PCT/EP2010/001566

§ 371 Date: Aug. 30, 2011

(30) Foreign Application Priority Data
Mar. 18, 2009 (DE) 102009013482

(51) Int. Cl. H01B 1/24; B82Y 30/00

(52) U.S. Cl. 252/511; 252/510; 977/842

(57) ABSTRACT

Process for dispersing nanoparticles, such as carbon nanotubes, in a medium-viscosity fluid by passing the fluid and nanoparticles through one or more multiscrew extruders having one or more kneading zones

The invention relates to a process for dispersing nanoparticles, in particular carbon nanotubes, in medium-viscosity fluid media.

Owing to their particular properties, nanoparticles have attained tremendous scientific and economic importance in recent years. Nanoparticles are defined by their size, i.e. they have at least one dimension which is less than 1 micron and greater than or equal to 1 nanometer.

Nanoparticles frequently occur as a dispersion in fluid media. A known example is colloidally bound gold on tin dioxide as support material in an aqueous dispersion, which was developed as a pigment by Andreas Cassius in 1685 and is known under the name of Purple of Cassius.

According to the generally known definition from hydrodynamics, fluid media (also referred to as fluids for short) are substances which do not resist a small shear stress. A fluid and the nanoparticles dispersed therein form a composite.

It is possible for the composite to be present as a fluid during its production and as a solid during its use. For example, nanoparticles can be dispersed in a fluid melt which then solidifies below the melting point to form a solid body. Composite and fluid are in this case also referred to as matrix in which the dispersed nanoparticles are “embedded”.

Known representatives of nanoparticles are, for example, carbon nanotubes. Carbon nanotubes, hereinafter also referred to as CNTs for short, are microscopically small tubular structures (molecular nanotubes) which consist predominantly of carbon. The diameter of the tubes is usually in the range 1-200 nm. Depending on the details of the structure, the electrical conductivity within the tube is metallic or semiconducting.

CNTs can be added to materials in order to improve the electrical and/or mechanical and/or thermal properties of the materials. Such composites comprising CNTs are known in the prior art. WO-A 2003/079375 discloses polymeric material which displays mechanically and/or electrically improved properties as a result of the addition of CNTs. WO-A 2005/015574 discloses compositions containing organic polymer and CNTs, where the CNTs form rope-like agglomerates. The compositions have a reduced electrical resistance and also a minimum level of notched impact toughness. The dispersion of CNTs in a polymer is preferably carried out in the polymer melt.

In the synthesis, CNTs are usually obtained in the form of tangled agglomerates. In this form, the CNTs cannot fully display their positive properties; for this reason, the agglomerates firstly have to be broken up and the CNTs ideally be individually isolated (“exfoliated”). For example, in order to increase the conductivity of polymer components, it is necessary to disperse the CNT agglomerates in the polymer melt in order for the CNTs to be able to form a three-dimensional network of conductive CNTs in the solid polymer matrix.

An important property of nanoparticle dispersion which is known to those skilled in the art is the increase in the viscosity compared to the fluid matrix. This increase is the more pronounced the more nanoparticles are present in exfoliated form and the better the resulting quality of the dispersion.

To disperse nanoparticle agglomerates in low-viscosity media having viscosities comparable with those of water (<0.1 Pa s), the method of ultrasound treatment is known. This is described, for example, in “Preparation of colloidal carbon nanotube dispersions and their characterisation using a disc centrifuge”, Carbon 46 (2008) 1384-1392. This method works, as indicated there, by cavitation, i.e. by formation and collapse of small vapour bubbles. In liquids having a relatively high viscosity, as are frequently used as intermediates for thermosets, elastomers or thermoplastics, the effect of cavitation no longer occurs because of the low vapour pressure of the liquid and the high viscosity. It is also known to those skilled in the art that ultrasound has only a very small range in liquids, so that this method comes into consideration primarily for the laboratory scale. A relatively high concentration of nanoparticles can likewise not be achieved by means of ultrasound since the increase in viscosity with increasing dispersion leads to reduced cavitation and thus to a reduced effect of the ultrasound. Furthermore, the increased viscosity reduces circulation in the ultrasonic bath, so that homogeneous dispersion is no longer ensured.

A further method known to those skilled in the art is dispersing nanoparticles by means of nozzle systems having a high pressure drop, e.g. high-pressure homogenizers or microfluidizers. The pressure for the nozzles has to be applied in each case by means of pumps. Such systems likewise have restrictions in terms of the viscosities which they can process. When the viscosity of the starting material is too high, the dispersion can no longer flow freely through the pumps. This method is therefore limited to dispersing nanoparticles in low- to medium-viscosity matrix liquids and to relatively low concentrations of nanoparticles.

A further method known to those skilled in the art is milling of the nanoparticle agglomerates in the medium in which they are to be dispersed, e.g. in ball mills or bead mills. Here, high viscosities lead to very high energy inputs which can allow the temperature of the dispersion to rise to such a level that the product quality can be impaired. In the case of CNTs, there is, in particular, the risk that CNTs will become jammed between the milling media, there be stressed to an excessive extent and therefore be shortened. This can lead to impairment of the properties in the finished composite. A further method known to those skilled in the art is dispersing nanoparticles in rotor-stator systems. These systems are self-priming and are therefore not able to process high-viscosity liquids. It is possible to improve the flow through rotor-stator systems by means of pumps. However, the feed to these pumps under gravity is, as in the case of the high-pressure nozzle systems, restricted by high viscosities. This method is therefore limited to dispersing nanoparticles in low- to medium-viscosity matrix liquids and to relatively low concentrations of nanoparticles.

A further method known to those skilled in the art is dispersion by means of roll mills, typically using a three-roll mill. This method is described, for example, in Carbon 46 (2008) 1384-1392. Here, very narrow gaps between the rolls, in the region of a few tens of microns, are used. Good dispersion qualities can be achieved for CNTs by means of this method without reducing the quality of the CNT dispersion as a result of an excessively high energy input. However, a disadvantage is that the CNTs cannot be used directly for the three-roll mill but instead firstly have to be predispersed in the liquid. Furthermore, scale-up to larger throughputs (>5 kg/h) is very difficult by means of this process since the throughput is proportional to the area of the gap (=roll width×gap height), but the gap height has to be kept constant for reasons of dispersion quality and enlarging the roll width inevitably leads to increased deformation of the rolls and thus to changes in the gap dimension.

The dispersion of CNTs in highly viscous thermoplastics by means of a twin-screw extruder is described, for example, in DE102007029008A1. Here, it is critical that the CNT agglomerates go through the melting zone together with the thermoplastic introduced as a solid since the friction of the solid decisively improves dispersion of the CNTs. The dispersion of nanoparticles, in particular CNTs, in medium-viscosity liquids using multiscrew extruders, preferably at room temperature (from 15° C. to 30° C.), is not known.

Proceeding from the prior art, it is therefore an object of the invention to discover a process for dispersing nanoparticles, in particular CNTs, in medium-viscosity fluid media, which process does not have the disadvantages of the prior art. The process sought should give good dispersion results, have not viscosity limits, make it possible to control the large increase in viscosity during dispersion and allow scale-up to higher throughputs.

It has surprisingly been found that dispersion of nanoparticles, in particular CNTs, in fluid media, in particular in fluid media which at the dispersing temperature have a viscosity in the range from 0.5 to 1000 Pa·s, by means of a multiscrew extruder can be carried out with good results.

The present invention accordingly provides a process for dispersing nanoparticles, in particular CNTs, in a medium-viscosity fluid medium, characterized in that the nanoparticles and the fluid medium together make a number m passages through one or more multiscrew extruders having one or more kneading zones, where m is an integer greater than or equal to 1.

For the purposes of the present invention, a medium-viscosity fluid medium is a medium having a viscosity in the range from 0.5 to 1000 Pa·s at the temperature at which dispersion is carried out. Viscosities indicated in the present document are always the viscosity measured using a commercial cone-plate rotational viscometer at constant shear at a shear rate of 1/s.

For the purposes of the present invention, a passage is the number of passes which the material being dispersed makes through a multiscrew extruder. In the case of a plurality of passages (m>1), the product can be sent a number of times through a multiscrew extruder or through different extruders, with the material once again being able to pass one or more times through each of the individual extruders.

Multiscrew extruders are known and are described, for example, in the book [1] ([1]=“Der gleichläufige Doppelschneckenextruder”, Klemens Kohlgrüber, Carl Hanser Verlag, ISBN 978-3-446-41252-1). Preference is given to using corotating twin-screw and multiscrew extruders which are preferably tightly intermeshing and thus self-cleaning.

A kneading zone is an arrangement of kneading elements. Transport elements can be arranged before and/or after a kneading zone.

The process of the invention is not restricted to screw elements made up of a screw having screw elements and core shafts according to the modular construction which is now customary, but can also be applied to screws having a one-piece construction. The terms transport elements and kneading elements therefore also encompass screws having a one-piece construction.

It is known (see, for example [1], pages 227-248) that the cross-sectional profile of a transport element is continuously twisted and propagated in a screw-like manner in the axial direction. The transport element can be right-handed or left-handed. The pitch of the transport element is preferably in the range from 0.1 times to 10 times the distance between the axes, with the pitch being the axial length required for a complete turn of the screw profile. As a result of the helical propagation of the cross-sectional profile in the axial direction, the product is transported on rotation of the extruder shaft.

It is known (see, for example, [1], pages 227-248) that the cross-sectional profile is propagated in sections in the form of kneading discs in the axial direction. The arrangement of the kneading discs can be right-handed or left-handed or neutral. The axial length of the kneading discs is preferably in the range from 0.05 times to 10 times the distance between the axes. The axial distance between two adjacent kneading discs is preferably in the range from 0.002 times to 0.1 times the distance between the axes. Product which transported in an extruder zone equipped with kneading elements is deformed.

In [1], the number of flights Z is also described as a characteristic parameter of a multiscrew extruder (see, for example, page 95). The number of flights is the number of depressions in the profile of a screw perpendicular to the axis of rotation of the screw. The kneading and transport elements used in the process of the invention can have one or more flights.

The transport elements used according to the invention preferably have one, two, three or four flights, particularly preferably one, two or three flights and particularly preferably one or two flights.

In a preferred embodiment in which the multiscrew extruder is configured as a corotating twin-screw extruder, one-flight transport elements are used at the tip of the twin-screw extruder. These transport elements ensure a particularly efficient pressure buildup at the outlet of the extruder.

The kneading elements used according to the invention preferably have one, two, three or four flights, particularly preferably one, two or three flights and very particularly preferably one or two flights. Eccentric discs always have one flight. They are round cylinder discs (circular discs) arranged eccentrically to the shaft and forming a narrowing gap into which product is drawn by the rotational motion and is stretched (see also [1] page 246).

Kneading elements which in terms of their contour correspond to the transport elements having crest, flank and groove ([1], p. 95ff, p. 107 ff.) are referred to as “angular”.

The angular kneading elements used according to the invention and the transport elements preferably have the same number of flights.

It has surprisingly been found that kneading elements whose contour can be represented by an always differentiatable profile curve are particularly effective in the process of the invention. The predominant number of screw elements known from the prior art are characterized by the profile curve in cross section having at least one crease which occurs at the transition between the screw crest and the flanks of the screw. The crease at the transition to the flank of the profile forms an edge on the screw element. If the profile curve in cross section has a crease, it cannot be represented by an always differentiatable curve.

Eccentrically arranged circular discs (eccentric discs) have a circular cross-sectional profile which can be represented by an always differentiatable curve.

In the process of the invention, preference is given to at least some kneading elements used having a cross-sectional profile which can be represented by an always differentiatable profile curve. Apart from the abovementioned eccentric discs, kneading elements having the cross-sectional profiles described in the as yet unpublished German patent application DE102008029303.2 are possible here.

Kneading elements whose contour can be represented by an always differentiatable profile curve will hereinafter also be referred to as kneading elements having a continuous contour. They can be used in the process of the invention both in corotating and in contrarotating multiscrew extruders.

A plurality of kneading discs are usually combined in one extruder element and arranged offset to one another. If the kneading discs having Z flights have an offset angle of 180°/Z, the arrangement of the kneading discs is described as transport-neutral. If the kneading discs have Z flights and an offset angle which is not equal to 180°/Z and are arranged in the same direction of rotation as the transport elements, they are referred to as transport-active. If the kneading discs have Z flights and an offset angle which is not equal to 180°/Z and they are arranged in the opposite direction of rotation as the transport elements, they are referred as backwards-transporting.

It has surprisingly been found that an arrangement of transport-active kneading elements, followed in the transport direction by transport-neutral or backwards-transporting kneading discs or a combination of transport-neutral and backwards-transporting kneading discs is particularly effective for dispersing nanoparticles in fluid media.

Preference is therefore given to using one or more multiscrew extruders having an arrangement of transport-active kneading elements, followed in the transport direction by transport-neutral or backwards-transporting kneading discs or a combination of transport-neutral and backwards-transporting kneading discs for dispersing nanoparticles in liquid media.

In particular, the arrangement of transport-active kneading discs, followed by possibly neutral and then backwards-transporting kneading discs does not lead to fluctuations in throughput and in the quality of dispersion. A person skilled in the art would have expected this because of the great increase in viscosity with increasing dispersion of the nanoparticles. This arrangement is preferably repeated a number of times in succession on an extruder, optionally separated by transport elements.

The speeds of rotation of the multiscrew extruders in the process of the invention can be selected in the range from 100/min to 1800/min, preferably from 200/min to 1200/min.

It has surprisingly been found that dispersion is particularly effective when the parameter K1, which can be calculated from the equation (1), is greater than 10, preferably greater than 20 and particularly preferably greater than 50, where the material being dispersed makes m passages numbered from i=1 to i=m (i=index of a passage) and each passage i has one or more kneading zones having a total length of LKᵢ and an internal barrel diameter Dᵢ.

$$K 1 = {\sum }_{i = 1}^{m} \frac{{LK}_{i}}{{D}_{i}} \qquad ( 1 )$$

The process of the invention for dispersing nanoparticles, in particular CNTs, in a medium-viscosity liquid medium is thus preferably characterized in that the nanoparticles and the fluid medium together make m passages through one or more multiscrew extruders, where each individual passage i has one or more kneading zones having a total length of LKᵢ and an internal barrel diameter of Dᵢ and the parameter

$$K 2 = {\sum }_{i = 1}^{m} {n}_{i} {tk}_{i} \qquad ( 2 )$$

is greater than 10, preferably greater than 20 and particularly preferably greater than 50.

It has surprisingly been found that particularly good dispersion of nanoparticles in fluid media can be achieved when the parameter K2, which can be calculated from the equation 2, is greater than 500, preferably greater than 2500 and particularly preferably greater than 5000, where the material being dispersed makes m passages numbered from i=1 to i=m (i=index of a passage) and in each case remains for a residence time of tkᵢ in one or more kneading zones in an extruder having a speed of rotation of nᵢ.

$$K 1 = {\sum }_{i = 1}^{m} \frac{{LK}_{i}}{{D}_{i}}$$

The process of the invention is thus preferably characterized in that the nanoparticles and the fluid medium remain for a residence time of tkᵢ in one or more kneading zones during the passage i and the parameter K2 according to equation (2) is greater than 500, preferably greater than 2500 and particularly preferably greater than 5000, where nᵢ is the speed of rotation of the multiscrew extruder present in the respective passage.

In the case of a plurality of passages (m>1), the product can, according to the invention, be sent a number of times through an extruder or else through different extruders, where the material can in turn go one or more times through each of the individual extruders. The residence time in the kneading zone is calculated as the product of the free cross-sectional area in the extruder multiplied by the length of the kneading zone divided by the throughput expressed as volume flow. The free cross section can, according to [1], p. 106, be approximated by the square of the diameter divided by two.

It has surprisingly been found that particularly good dispersion of nanoparticles, in particular CNTs, in medium-viscosity fluid media can be achieved when the parameter K3, which can be calculated from equation 3, is greater than 300, preferably greater than 2000 and particularly preferably greater than 4000, where the product makes m passages numbered from i=1 to i=m (i=index of a passage) and remains in each case for the residence time teᵢ in one or more zones having kneading elements having a continuous contour in an extruder having a speed of rotation of nᵢ.

$$K 3 = {\sum }_{i = 1}^{m} {n}_{i} {te}_{i} \qquad ( 3 )$$

The process of the invention is therefore preferably characterized in that the nanoparticles and the fluid medium remain for a residence time teᵢ in one or more zones having kneading elements having a continuous contour during the passage i and the parameter K3 according to the equation (3) is greater than 300, preferably greater than 2000 and particularly preferably greater than 4000, where nᵢ is the speed of rotation of the multiscrew extruder present in the respective passage.

Dispersion according to the invention is preferably carried out at room temperature (from 15° C. to 30° C.), with the temperature of the material being dispersed being able to rise to temperatures above ambient temperature (room temperature) during dispersion as a result of the energy input. Heat which is produced in the extruder as a result of the dispersion process is preferably removed via the extruder barrel in order to reduce the maximum temperature of the material being dispersed and thereby make high speeds of rotation and thus a high energy input possible.

Metering of nanoparticles and fluid medium into the same input opening, as suggested by DE102007029008A1, is found to be problematical. Here, viscous liquid can wet the feed hopper, which can lead to nanoparticle agglomerates sticking to the feed hopper and thus leading to nonuniform introduction, which can result in fluctuations in quality and, in the case of periodic introduction of too large a quantity of nanoparticles, to stoppage of the extruder.

It has surprisingly been found that it is advantageous to meter the nanoparticles dry into a feed hopper of the extruder and introduce the fluid medium downstream thereof via a valve.

The nanoparticles are therefore preferably metered dry into a feed hopper of the extruder in the process of the invention, while the medium-viscosity fluid medium is introduced downstream thereof. Transport elements are located underneath the feed hopper and also between feed hopper and point of introduction of the fluid medium. The transition to a kneading zone is therefore located downstream of the point of introduction. Contrary to expectations, there are therefore no adverse effects in respect of blockage of the extruder screws when, for example, using CNTs as nanoparticles and polyol Acclaim 18200 N from Bayer MaterialScience AG as fluid medium at a temperature of 20° C.

This preferred embodiment of the process of the invention is advantageous because the nanoparticles, in particular CNTs, can be metered in dry agglomerate form and the complicated production of a predispersion composed of nanoparticle agglomerates and fluid medium is therefore not necessary.

The concentrations of nanoparticles which are dispersed according to the invention in the fluid medium are in the range from 0.001% to 50%, preferably from 0.01% to 30% and particularly preferably from 0.04% to 20%.

The process of the invention is therefore suitable, in particular, for producing a precondensate of a nanoparticle dispersion, in particular a CNT dispersion, which can be diluted with further fluid before use. The ratio of precondensate to further fluid can be in the range from 1:1000 to 3:1, preferably in the range from 1:100 to 1:1, particularly preferably in the range from 1:50 to 1:3. The fluid which is constituent of the precondensate can be the same fluid as used for dilution or another fluid. A preferred variant is for the two fluids to be identical. A further preferred variant is that the fluid of the precondensate has identical chemical functionality as the further fluid but differs in at least one feature such as viscosity, molecular weight, number of functional groups per molecule. The viscosity of the fluid which is constituent of the precondensate is particularly preferably a factor of from 10 is 1000 lower than that of the fluid used for dilution. A further preferred variant is that the precondensate is produced using a chemically inert fluid or a mixture of a chemically inert fluid and a fluid which has the same chemical functionality as the further fluid, with the chemically inert fluid being removed during further processing.

The process of the invention is preferably carried out using CNTs as nanoparticles. The essentially cylindrical CNTs can have a single wall (single wall carbon nanotubes, SWNTs) or a plurality of walls (multiwall carbon nanotubes, MWNT). They have a diameter d in the range from 1 to 200 nm and a length/which is a number of times the diameter. The ratio l/d (aspect ratio) is preferably at least 10, particularly preferably at least 30. The CNTs consist entirely or mainly of carbon. Accordingly, carbon nanotubes containing “foreign atoms” (e.g. H, O, N) are, for the purposes of the present invention, also considered to be carbon nanotubes as long as the main constituent is carbon.

The CNTs to be used preferably have an average diameter of from 3 to 100 nm, preferably from 5 to 80 nm, particularly preferably from 6 to 60 nm.

Customary processes for producing CNTs are, for example, arc discharge, laser ablation, chemical deposition from the vapour phase (CVD process) and catalytic chemical deposition from the vapour phase (CCVD process).

Preference is given to using CNTs obtainable from catalytic processes since these generally have a lower proportion of, for example, graphite- or soot-like impurities. A particularly preferred process for producing CNTs is known from WO-A 2006/050903.

The CNTs are generally obtained in the form of agglomerates which have an equivalent sphere diameter in the range from 0.05 to 2 mm.

In the process of the invention, preference is given to using fluid media which at room temperature (from 15° C. to 30° C.) have a viscosity in the range from 0.5 to 1000 Pa·s. Fluid media used in the process of the invention can, for example, be from the group consisting of isocyanates, modified isocyanates, polyols, epoxy resins, polyester resins, phenol-formaldehyde resins, melamine resins, melamine-phenol resins and silicones.

The fluids to be used can also be prepolymers which, after dispersion, are converted by chemical reactions such as polymerization or crosslinking reactions into thermosets, elastomers or thermoplastics, for example cyclic polybutylene terephthalate or cyclic polycarbonate.

The viscosity of the dispersions produced can be in the range from 5 to 100 000 Pa·s.

The invention is illustrated below with the aid of examples and figures, but without being restricted thereto.

In the figures:

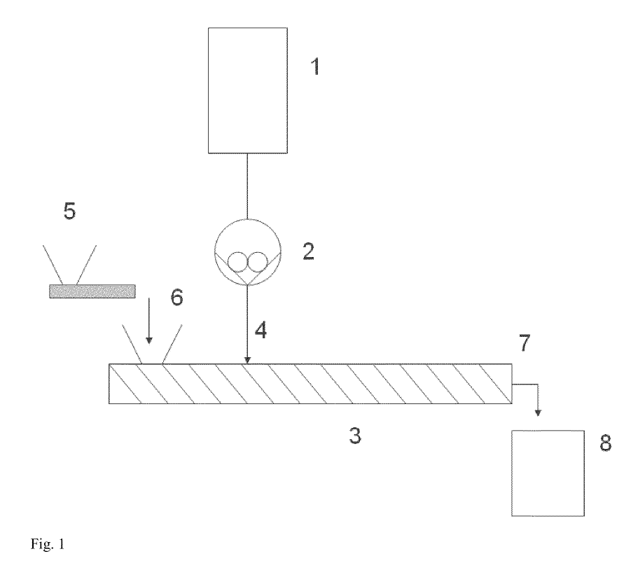

FIG. 1 shows an apparatus for carrying out a preferred embodiment of the process of the invention,

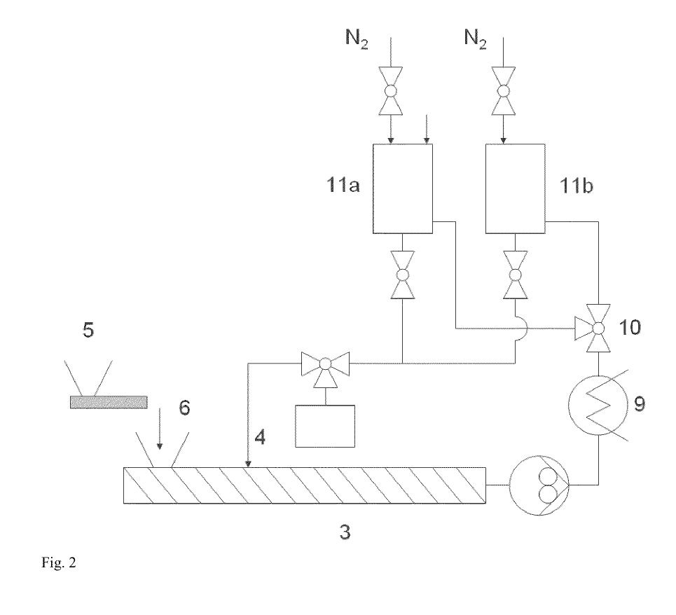

FIG. 2 shows an apparatus for carrying out a further preferred embodiment of the process of the invention,

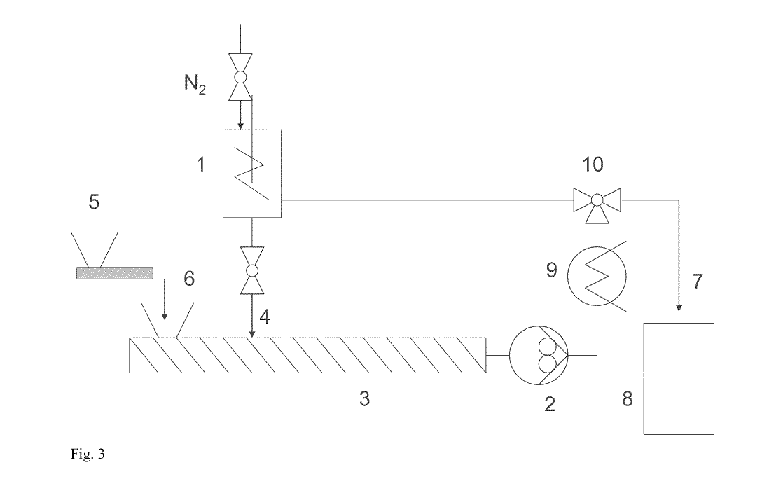

FIG. 3 shows an apparatus for carrying out a further preferred embodiment of the process of the invention,

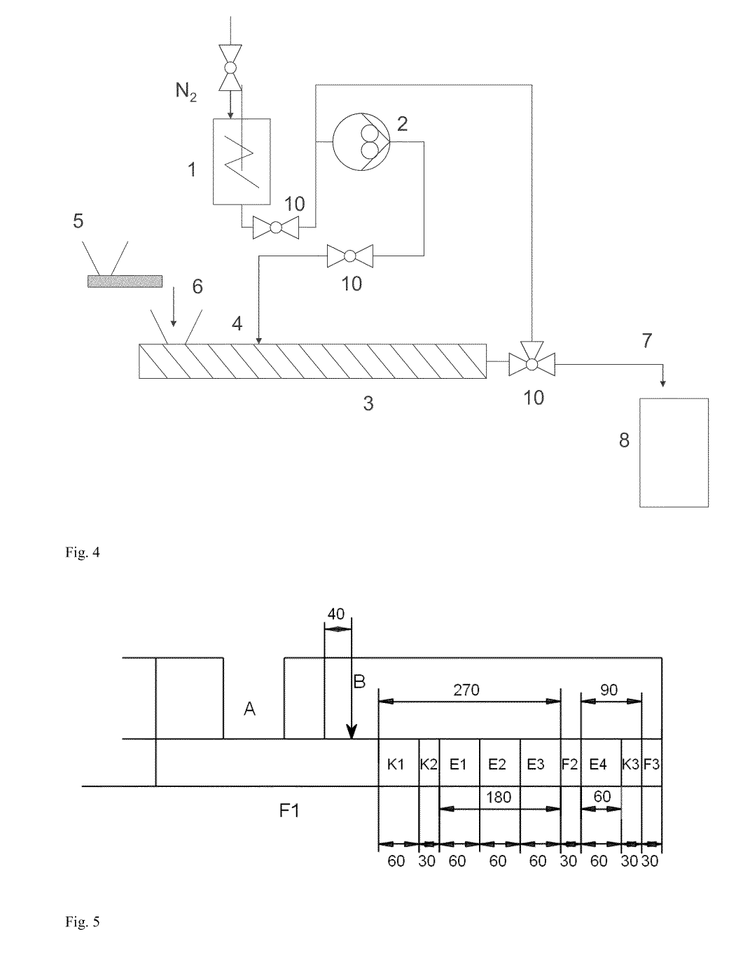

FIG. 4 shows an apparatus for carrying out a further preferred embodiment of the process of the invention,

FIG. 5 shows the configuration of a multiscrew extruder which can be used in the process of the invention.

In all figures, the same reference numerals have the same meaning.

### REFERENCE NUMERALS

1 stock vessel
2 transport means
3 extruder
4 input
5 gravimetric metering
6 solids intake/feed hopper
7 output
8 collection vessel
9 heat exchanger
10 valve
11a, 11b vessels for stock and collection

In a preferred embodiment of the process of the invention, the nanoparticle dispersion, in particular the CNT dispersion, is produced in a single pass through the multiscrew extruder. FIG. 1 shows an example of an apparatus by means of which such a process variant can be carried out. A fluid medium is taken from the stock vessel (1) and metered by means of a transport means (2), e.g. a gear pump, into the extruder (3). Introduction occurs through an inlet (4) (e.g. a drilled hole) into a closed barrel section. The nanoparticles, in particular CNTs, are metered in dry form by gravimeteric metering (5) (e.g. via a metering balance) into the extruder via a solids intake (6) upstream of the point of introduction of the fluid. The dispersion leaves the extruder via the output (7) (e.g. a nozzle) and goes into the collection vessel (8).

In a further preferred embodiment of the process, the nanoparticle dispersion, in particular the CNT dispersion, is produced in a plurality of passes through the multiscrew extruder. FIG. 2 shows an example of an apparatus by means of which such a process variant can be carried out. From a preferably stirred stock vessel (11a), a fluid is fed via an inlet (4) (e.g. through a nozzle) into the extruder (3) by means of superatmospheric pressure (here shown as a superatmospheric pressure generated by means of nitrogen (N₂)). Upstream, dry nanoparticle agglomerates, in particular CNT agglomerates, are fed into the extruder via the feed hopper (6) by means of the gravimetric metering facility (5). At the output of the extruder, the product is recirculated by means of a transport means (2) (e.g. a gear pump) via a heat exchanger (9) to remove heat into the stock vessel (11a). When the desired quality of dispersion has been achieved, the product is fed into the vessel (11b) by switching over the valve (10).

As heat exchanger, it is possible to use, for example, a shell-and-tube heat exchanger, a plate heat exchanger or a single-channel or multichannel heat exchanger having static mixer internals.

In the case of a plurality of passages through the extruder, two phases can be distinguished: a first phase of production of a first dispersion of nanoparticles in the pure fluid and a second phase in which dispersion is improved further by further passages through the extruder.

In the second phase, preference is given to an embodiment having at least two vessels (11a, 11b) in which the product leaving the extruder is in each case collected in a vessel (e.g. 11b) and the extruder is supplied from the other vessel (e.g. 11a). When the vessel (11a) from which the extruder is supplied is nearly empty, the two vessels reverse their roles. The vessels are preferably cooled and stirred. The dispersion can be conveyed from the vessels by means of, for example, gas pressure or pumps.

In a further preferred embodiment of the process of the invention, in the second phase the extruder transports from the same vessel from which it is supplied. FIG. 3 shows an example of such an arrangement. Nanoparticles are introduced gravimetrically (5) into the extruder. The fluid medium is introduced via an inlet (4) into the extruder. The material being dispersed can be recirculated via the valve (10) into the stirred stock vessel (1) and conveyed through the extruder a number of times before it is fed via the valve (10) and the outlet (7) into the collection vessel (8). Before recirculation to the stock vessel (1), heat is removed from the material being dispersed via the heat exchanger (9).

FIG. 4 shows an arrangement in which the dispersed product is directly recirculated from the extruder via a transport means (2) which in the present example is a gear pump.

FIG. 5 shows the configuration of an extruder as can be used according to the invention. At A, the nanoparticles are metered in dry form into the intake of the extruder. The liquid is metered in at the feed point B. The material being dispersed is fed by means of the transport elements in the region F1 into a first kneading zone K1, K2, E1, E2, E3. Dispersion is effected in the kneading regions having an angular contour K1, K2 and the kneading regions having a continuous contour E1, E2, E3. These regions are separated by a short transport region F2 from a second leading zone. The kneading regions E4 (continuous contour) and K3 (angular contour) follow, followed by a transport region F3 which builds up the pressure for the discharge zone of the extruder.

The kneading regions K1, K2 and E1 are transporting in the present example, the kneading region E2 is transport-neutral and the kneading region E3 is backwards-transporting. The kneading region E4 is transporting and the kneading region K3 is backwards-transporting.

The figures indicate the length of the respective regions in millimetres (mm).

### Example 1

### Dispersion of CNT in a Polyol in a Single Pass Through an Extruder

In an apparatus as shown in FIG. 1, 5.28 kg/h of polyol Acclaim 18200 N from Bayer MaterialScience AG were introduced into a corotating twin-screw extruder having an external diameter of 34 mm. Upstream thereof, 0.163 kg/h of Baytubes C 150 P from Bayer MaterialScience AG were introduced. The configuration of the extruder corresponded to that shown in FIG. 5. The total length of all kneading elements was 360 mm, the total length of all kneading elements having a continuous contour was 270 mm, the rotational speed was 264/min, with a single passage.

The parameter K1 calculated according to equation (1) is 10.9, the parameter K2 calculated according to equation (2) is 624 and the parameter K3 calculated according to equation (3) is 468. The dispersion result was evaluated by means of light-microscopic photographs. The size of the agglomerates was reduced to values of less than 200 microns. Furthermore, a high proportion of finely dispersed CNTs can be seen. The viscosity of the dispersion was 106 Pa·s at a shear rate of 1/s, measured in a cone-plate rotational rheometer at constant shear.

### Example 2

### Dispersion of CNTs in a Polyol Using 10 Passages Through an Extruder

In an apparatus as shown in FIG. 2, 10.08 kg/h of polyol Acclaim 18200 N from Bayer MaterialScience AG were introduced into the extruder as in Example 1. The concentration of CNTs, Baytubes C 150 P from Bayer MaterialScience AG, was 3% by weight. The number of passages was 10. The rotational speed of the extruder was 264/min. The parameter K1 calculated according to equation (1) is 109, the parameter K2 calculated according to equation (2) is 3270 and the parameter K3 calculated according to equation (3) is 2452.

The dispersion result was evaluated by means of light-microscopic photographs. it was significantly better than in the case of Example 1. The largest particle size found was less than 10 microns, and the proportion of finely dispersed CNTs is significantly higher than in the case of the dispersion in Example 1. The viscosity of the dispersion was 638 Pa·s at a shear rate of 1/s, measured in a cone-plate rotational rheometer at constant shear.

1. A process for dispersing nanoparticles in a medium-viscosity fluid medium, wherein the nanoparticles and the fluid medium together make a number m passages through one or more multiscrew extruders having one or more kneading zones, where m is an integer greater than or equal to 1.

2. The process of claim 1, wherein each single passage i has one or more kneading zones having a total length of LKᵢ and an internal barrel diameter of Dᵢ and the parameter K1
$$K 1 = {\sum }_{i = 1}^{m} \frac{{LK}_{i}}{{D}_{i}}$$
is greater than 10

3. The process of claim 1, wherein the nanoparticles and the fluid medium remain for a residence time of tkᵢ in one or more kneading zones during the passage i and the parameter K2
$$K 2 = {\sum }_{i = 1}^{m} {n}_{i} {tk}_{i}$$
is greater than 500, where nᵢ is the rotational speed of the multiscrew extruder present in the respective passage.

4. The process of claim 1, wherein at least part of the kneading zone(s) is formed by kneading elements whose cross-sectional profile can be represented by an always differentiatable profile curve.

5. The process of claim 4, wherein the nanoparticles and the fluid medium remain for a residence time of teᵢ in one or more zones having kneading elements whose cross-sectional profile can be represented by an always differentiatable profile curve during the passage i and the parameter K3
$$K 3 = {\sum }_{i = 1}^{m} {n}_{i} {te}_{i}$$
is greater than 300, where nᵢ is the rotational speed of the multiscrew extruder present in the respective passage.

6. The process of claim 1, wherein one or more of said multiscrew extruders have an arrangement of transport-active kneading elements, followed in the transport direction by transport-neutral or backwards-transporting kneading discs or a combination of transport-neutral and backwards-transporting kneading discs.

7. The process of claim 1, wherein the nanoparticles are metered dry into a feed hopper of a multiscrew extruder while the medium-viscosity fluid medium is introduced downstream thereof.

8. The process of claim 1, wherein a precondensate is produced in a first step and is diluted with further fluid medium in a second step.

9. Process according to claim 8, wherein the ratio of the precondensate to the further fluid medium is in the range from 1:1000 to 3:1.

10. Process according to claim 8, wherein the further fluid medium differs in at least one feature selected from the group consisting of viscosity, molecular weight, number of functional groups per molecule.

11. Process according to claim 1, wherein said nanoparticles are carbon nanotubes.

12. Process according to claim 1, wherein the fluid medium has a viscosity in the range from 0.5 to 1000 Pa·s at 15° C. to 30° C.

13. Process according to claim 1, wherein the fluid medium is one or more compounds selected from the group consisting of isocyanates, polyols, epoxy resins, polyester resins, phenol-formaldehyde resins, melamine resins, melamine-phenol resins, silicones and prepolymers.

14. The process of claim 2, wherein K1 is greater than 20.

15. The process of claim 14, wherein K1 is greater than 50.

16. The process of claim 3, wherein K2 is greater than 2500.

17. The process of claim 16 wherein K2 is greater than 5000.

18. The process of claim 5, wherein K3 is greater than 2000.

19. The process of claim 18, wherein K3 is greater than 4000.
